(19) United States
(12) Patent Application Publication
(10) Pub. No.: US 2009/0253111 A1
(43) Pub. Date: Oct. 8, 2009

(54) MULTIMEDIA INSTRUCTIONAL SYSTEM

(76) Inventors: Bruce Teicher, Chagrin Falls, OH (US); Crystal Teicher, Chagrin Falls, OH (US)

Correspondence Address: Fay Sharpe LLP, 1228 Euclid Avenue, 5th Floor, The Halle Building, Cleveland, OH, 44115, US

(21) Appl. No.: 12/420,377

(22) Filed: Apr. 8, 2009

Related U.S. Application Data
(60) Provisional application No. 61/123,380, filed on Apr. 8, 2008.

(51) Int. Cl. G09B 5/00

(52) U.S. Cl. 434/308

(57) ABSTRACT

A multimedia instructional guide allows a user to proceed step-by-step through a selected task. The guide stops at the end of each step until the user is ready to proceed to the next step. The information presented includes a collection of video clips, images, sounds, and text.

### BACKGROUND

The instant application relies for priority on Provisional Application Ser. No. 61/123,380 which was filed on Apr. 8, 2008. The subject matter of the provisional application is incorporated hereinto by reference, in its entirety

The present disclosure pertains to a multimedia instructional system.

Instructional manuals which help people improve their homes, their health, their parenting abilities or the way they cook are well known. So are travel guides. In the vast majority of cases, these are in the form of books, rather than being interactive. It would be beneficial, whether a person is trying to cook a soufflé, build a deck, tour New York City or diaper a baby, to have a personal guide. It would also be advantageous if the information was presented in an easy to follow step-by-step fashion with a collection of video clips, images, sounds and text.

Video presentations on DVDs, video tapes and the like, as well as over the internet, are known for a large variety of tasks, such as cooking, gardening and the like. However, each of these runs through a complete program, rather than stopping at the end of each step, to ensure that the person completes that step of the task before advancing to the next step.

### BRIEF SUMMARY

An interactive instructional system includes a player which can accommodate at least one guide that contains a collection of video clips, images, sounds, and text. The guide stops at the end of each step.

A multi media instructional guide according to one embodiment of the present disclosure comprises a player including a display, a processor connected to the display and to an internal memory, and a media reading module connected to the processor. A portable memory device holding a set of discrete video clips organized into sets and subsets is selectively connected to the media reading module. Only a selected one video clip is played when a control is activated on the player. The control needs to be activated a second time before another video clip can be played.

According to another embodiment of the present disclosure, a user controlled interactive video system comprises a video player adapted to respond to an input command from a user to play a video clip. The player comprises a display, a processor connected to the display, a data input module connected to the processor and a control for selectively actuating the data input device. An external memory device is selectively connected to the data input module. The external memory device carries a set of discrete video clips, each of which can be individually accessed. When the control is actuated, a selected video clip is displayed on the display of the video player. The control needs to be actuated a second time before another video clip can be displayed.

### BRIEF DESCRIPTION OF THE DRAWINGS

The disclosure may take physical form in certain parts and arrangements of parts, a preferred embodiment of which will be described in detail in this specification and illustrated in the accompanying drawings which form a part hereof and wherein:

FIG. 1 is a front elevational view of a player used in the instructional system according to the present disclosure;

FIG. 2 is a top plan view of the player;

FIG. 3 is a bottom plan view of the player;

FIG. 4 is an exploded perspective view of various components in the instructional system according to the present disclosure;

FIG. 5 is an enlarged top plan view of a remote control for the player of FIG. 1;

FIG. 6 is a view of a main screen menu of one instructional guide which can be displayed on the player of FIG. 1;

FIG. 7 is a view of one subsection of the screen menu of the instructional guide of FIG. 6;

FIG. 8 is a view of another subsection of the screen menu of the instructional guide of FIG. 6;

FIG. 9 is a view of a still further subsection of the screen menu of the instructional guide of FIG. 6;

FIG. 10 is a view of a yet further subsection of the screen menu of the instructional guide of FIG. 6;

FIG. 11 is a schematic view of another type of a screen menu of instructional guide which can be displayed in the player of FIG. 1;

FIG. 12 is a schematic view of a screen menu of a further instructional guide section for home and gardening;

FIG. 13 is a flow chart of a first portion of a software program employed in the system of FIG. 4; and

FIG. 14 is a flow chart of another section of the software program employed in the system of FIG. 4.

### DETAILED DESCRIPTION

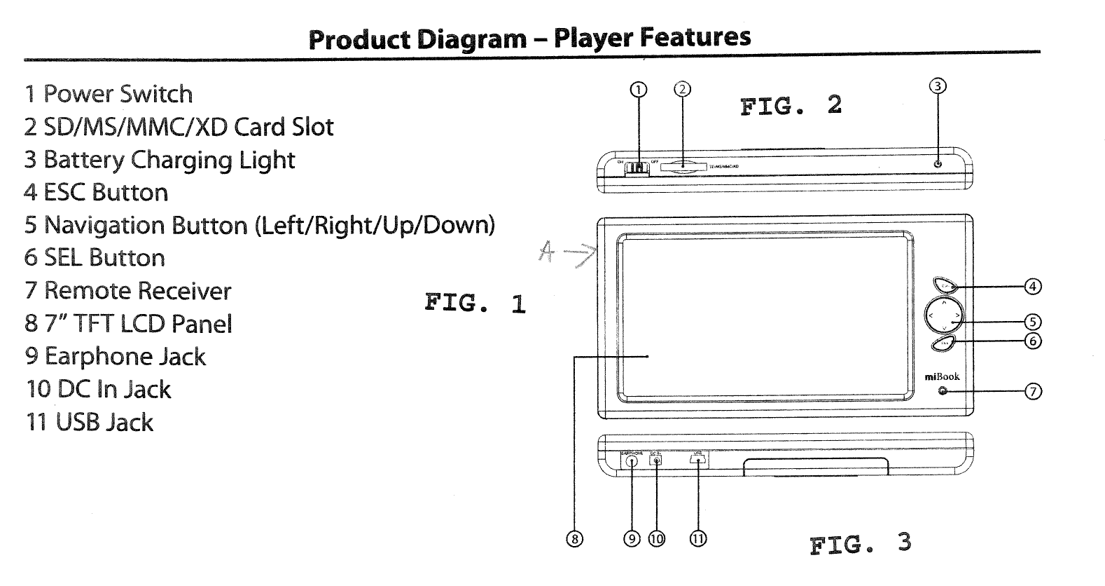

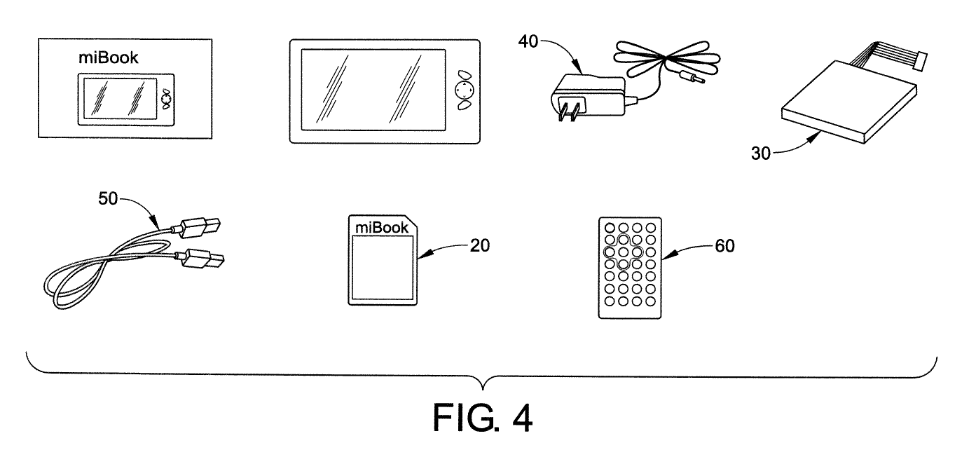

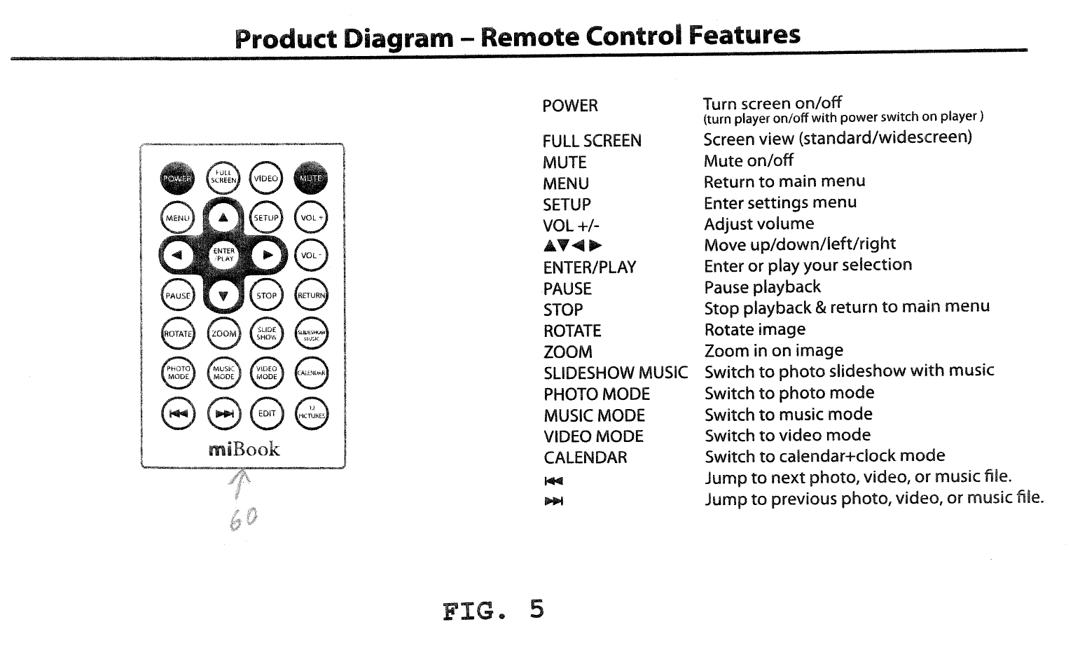

Referring now to the drawings wherein the showings are for purposes of illustrating embodiments of the disclosure only and not for purposes of limiting same, FIG. 1 shows a player used in the system disclosed herein. The player A can be somewhat rectangular in shape. With reference now to FIG. 2, the player includes a power switch 1, an SD/MS/MMC/XD card slot 2 and a battery charging light 3. It should be apparent that a variety of different types of cards can be accommodated in the card slot 2. Each of these cards (such as card 20 illustrated in FIG. 4) would contain the instructional or “how-to” information which is to be displayed on the player.

Of course, it is to be understood that, in addition to a memory card, the instructional information may be in an alternative form of computer readable media. Common forms of computer-readable media include, for example, a floppy disk, a flexible disk, hard disk, magnetic tape, or any other magnetic medium, a CD-ROM, any other optical medium, a RAM, a PROM, an EPROM, a FLASH-EPROM, a flash drive, a memory card, any other memory chip or cartridge, a carrier wave as described hereinafter, or any other medium from which a computer (or processor) can read. Further, the instructional information could be downloaded from the Internet and stored on computer-readable media.

Thus, although not shown, the player typically includes a controller having a processor. Instructions and data to control operation of the processor in accordance with the present invention are stored in a memory which is in data communication with the processor. Typically, the player will include both volatile and non-volatile memory and possibly more than one of each type of memory, with such memories being collectively represented by the memory.

The main components of an exemplary memory typically include RAM, EPROM and a mass storage device. The RAM typically temporarily holds program files for execution by the processor and related data. The EPROM may be a boot ROM device and/or may contain some system or video related code. The mass storage device may be used to store video data, the integrity of which may be verified and/or authenticated by the processor using protected code from the EPROM or elsewhere.

With reference again to FIG. 1, the player further includes an escape button 4, a navigation button 5 and an SEL or “select” button 6. Located beneath the set of buttons 4-6 is a remote receiver 7. Disposed to one side of the set of buttons 4-6 is a display panel 8. In one embodiment, the display panel can be a TFT LCD panel.

With reference now to FIG. 3, disposed along a bottom surface of the player A can be an earphone jack 9, a charging jack 10 and a USB jack or port 11.

With reference now to FIG. 4, the system, in addition to the player A also includes, as mentioned, one or more cards 20 which can be accommodated in the card slot 2 shown in FIG. 2. The system also includes a battery 3.0, such as a lithium ion battery, as well as a power adapter 40. As mentioned, the power adapter 40 plugs into the power in jack 10 illustrated in FIG. 3. This can be a D.C. jack. A USB cable 50 can be employed to connect the player A to a suitable computer device. Also disclosed is a remote control 60 which cooperates with the remote receiver 7 shown in FIG. 1.

With reference now to FIG. 5, it can be seen that the remote control enables a variety of functions to be performed by the player. These include a photo mode, a music mode, a video mode and a calendar mode. As might be expected, the remote control includes a power button, a mute button and volume and play buttons, as well as up, down, left and right buttons. Further included are pause and stop buttons. For the video aspect of the player, there are provided rotate, zoom and full screen buttons, as well as a slide show music button. Moreover, there are provided forward and back buttons to enable a user to jump to the next photo, video or music file or to the previous photo, video or music file. Also located on the remote control can be an edit button and a button that enables the player to display twelve pictures at the same time.

The player of the present disclosure is useful for a variety of instructional, guide or teaching tasks. The system disclosed herein enables a person to be guided, for example, through recipes step-by-step, letting the cook see how each dish should look every step of the way. For example, once the person is done dicing onions for a recipe which calls for onions, he or she would touch the select button 6 and get ready for the next step, such as, e.g., sautéing. The instructions would describe the technique for sautéing and the cook could see exactly what the onions should look like when they are done. The system enables a person to plan menus, e.g., chicken or beef, grill or oven, in a rush or have an hour, low fat or calories are not a concern. By proper selection, the person would be guided to the perfect recipe for a particular situation.

The system is capable of being used in a variety of do-it-yourself situations in addition to cooking. These would include, e.g., a landscaping, home design or home repair, among others. In other words, a person would be guided through the fixing of a toilet or the rewiring of a lamp. Moreover, education can be given on room decoration and the like in a step-by-step fashion.

In addition, the system can be used for travel, becoming a personal tour guide. It brings a trip to life with on the spot video clips, sound bites, photos and more. In sum, the knowledge of a veteran tour guide is at the fingertips of a tourist. As one example, when touring a museum, the user could hear an interview with an artist, see his home town and watch his technique. When selecting a restaurant, the user could tour the restaurant, hear the chef, see the signature dishes, view menus, and the like. When touring, information could be given on what a particular site looked like many years ago or the tourist could listen to inhabitants of that location talk about their lives.

As to parenting, the information provided would guide a parent step-by-step through every childcare activity with video clips, images and sound. The information provided is like having a professional nanny at one's side. The benefit is that the person wouldn't just read about how to diaper, swaddle, feed, walk, talk, discipline or take care of a child, but would see the task being performed as well.

The system discussed herein is better than a book or magazine because it lets the user see and hear exactly how tasks are performed. Moreover, it is better than television because it is personal, portable and interactive. It empowers the user to find the information the user wants, when the user wants it and put it to immediate practical application or use.

In one embodiment, an inexpensive digital photo frame chip set was employed for the player. In other words, rather than using a more powerful, more complicated and expensive microprocessor system, an inexpensive system was used for playing discrete video clips. The clips can be used as a step-by-step teaching tool/guide. A ladder structure devised for ordering photos was used to both sort and access lessons in the form of video clips and for causing steps of the lesson to play in sequence, each time the select or play button 6 is pressed. Alternatively, a play button on a remote could be employed. The ordering function of the chip set was employed including an automatic stop capability of unlimited duration. This is necessary because some tasks may require up to thirty minutes or more to be done. The method for moving to the next step is for the user to simply push the player select or “play” button again. This triggers the next video sequence to play. When the sequence ends, the video automatically stops. This allows for a user selected variable time to complete a task before moving on to the next task. The several video clips can be employed to tell the entire story or give an entire lesson.

Because the device is portable, a person can move around the kitchen or around a deck that is being worked on. Alternatively, the device can be brought on a trip, as a portable tour guide or the like. Moreover, on a trip, because the device is also a digital photo frame, one can show pictures to the people that are met on the trip and/or view pictures taken on the trip while still on the trip.

Unlike an instructional DVD or video tape, the disclosed player, instructional guide or video system allows a lesson to be much more interactive in terms of choosing and quickly accessing individual sequences. Moreover, the present system automatically stops at the end of each sequence, how-to segment or step. Thus, step-by-step discrete videos are held on the memory card or similar storage device. These can be individually selected by the user as desired. Held on the storage device can be integrated lessons, photos, movies, video clips, music and the like.

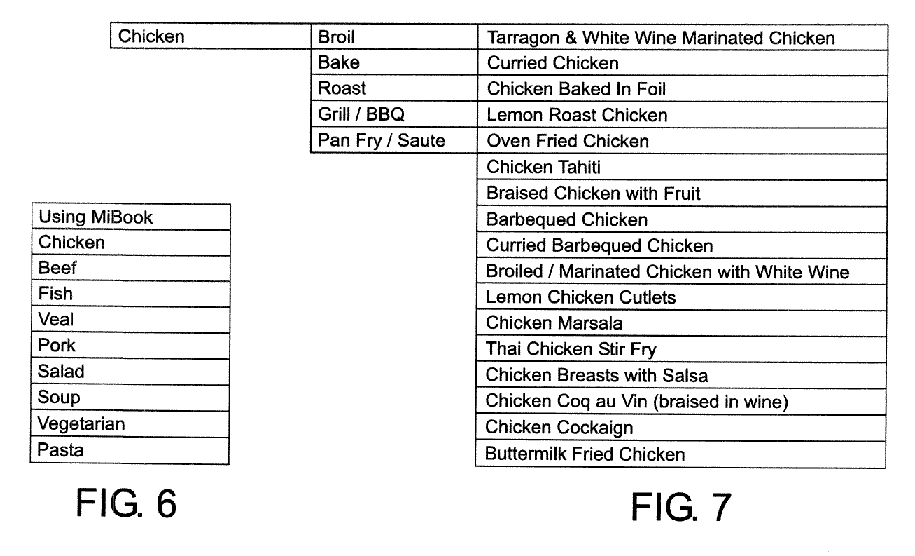

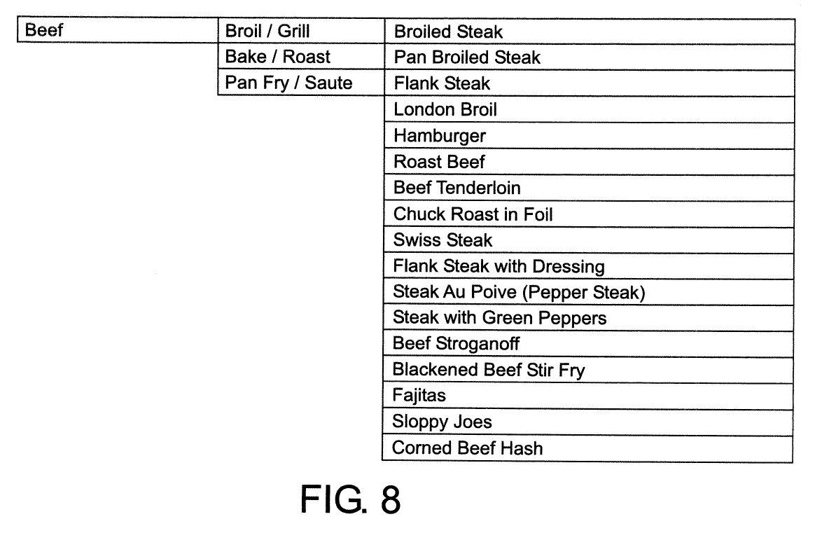

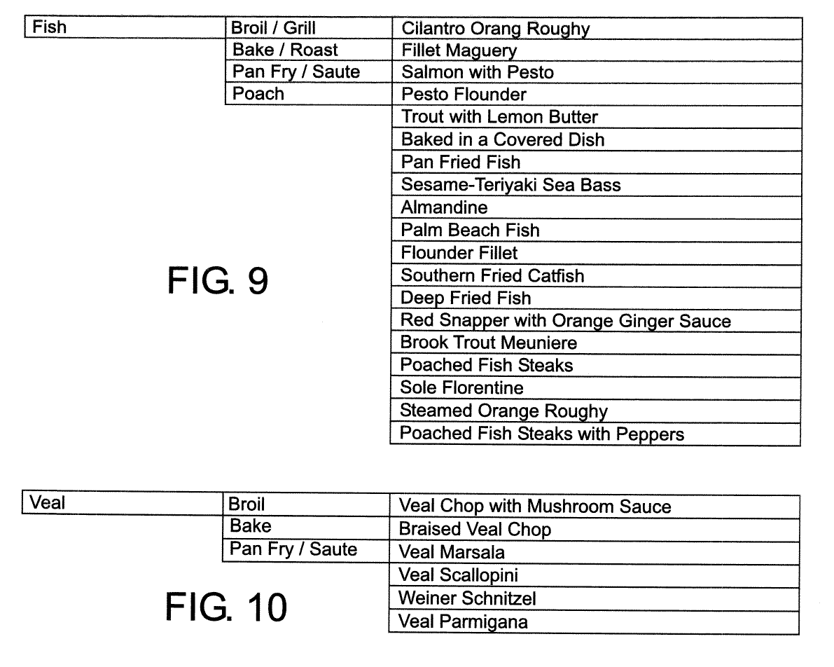

With reference now to FIG. 6, a cooking instructional system will be discussed in greater detail. Upon insertion of a cooking card 20 into the player A, the user would see a main menu, which is categorized by the main ingredient of each dish. Also, appearing on the main menu is information on how to use the system. Assuming that the user wished to make a chicken dish, the menu would display various ways of making the dish and the particular dish that can be made. With reference to FIG. 7, for example, if the user wanted to make chicken and roast the chicken, one of the menu items displayed would be curried barbecue chicken. With reference now to FIG. 8, if, instead, the user wanted to make a beef dish and wanted to broil the beef, a selection would be flank steak. If, instead, the user wished to make a fish dish and wanted to pan fry or sauté the fish, a selection would be flounder fillet as shown in FIG. 9. Similarly, as shown in FIG. 10, for a veal dish that was baked, a menu selection would be braised veal chop.

In one embodiment, up to 300 recipes could be contained on the card 20. It should be recognized, of course, that other ways of organizing the information could also be employed. These could include a method of cooking, time available, the amount of calories in a dish and so on. It should be appreciated that the 300 or so menus on a single menu card could be organized or categorized in a variety of ways so that a person could search not only by main ingredient but also by time available or amount of calories on the same mass storage card or other storage device.

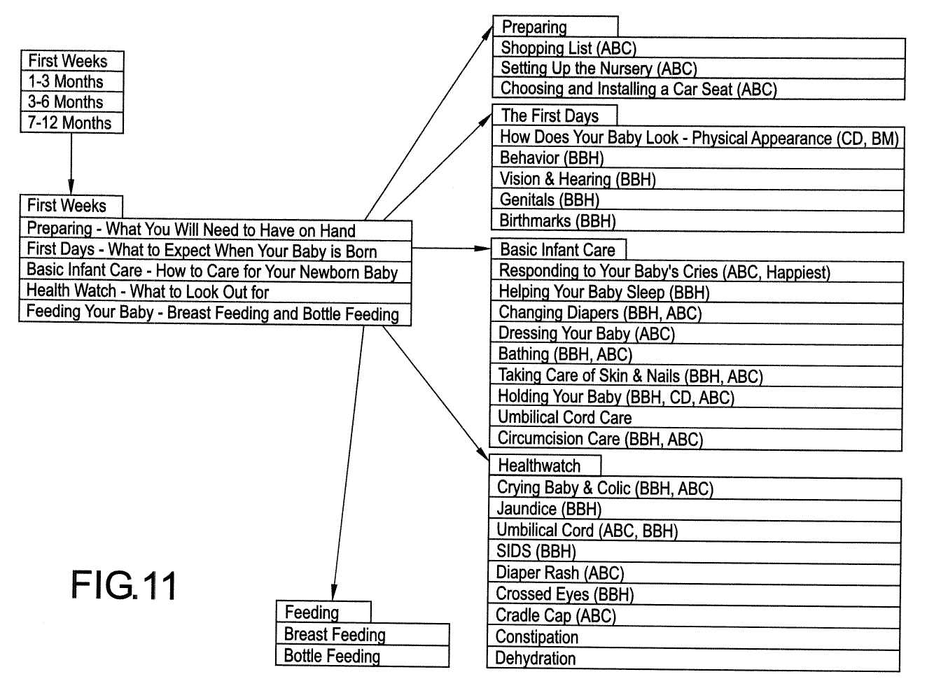

With reference now to FIG. 11, another type of guide is there illustrated, this guide pertains to the parenting of a very young child. The main menu or directory shows various categories concerning the age of the child. If the child is in its first weeks, the sub directory is organized as to what items the parent needs to have on hand, the first days of the child, basic infant care, etc. As to basic infant care, for example, categorized in that subdirectory are a series of informational items dealing with changing diapers, dressing the baby, umbilical cord care, etc. Each of these, in turn, will lead to an audio visual or multimedia presentation on the player A for that particular item or task.

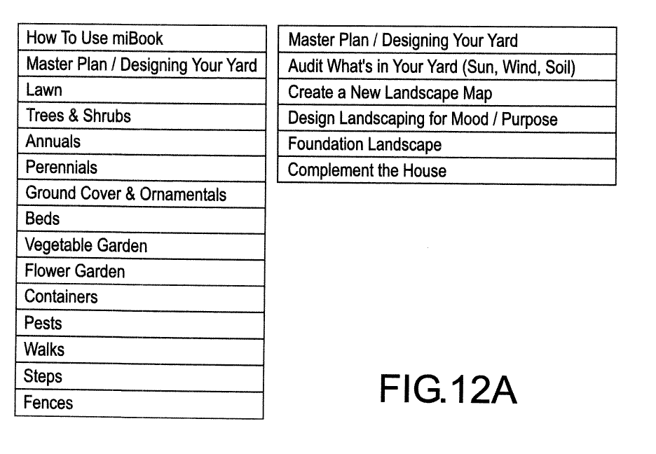

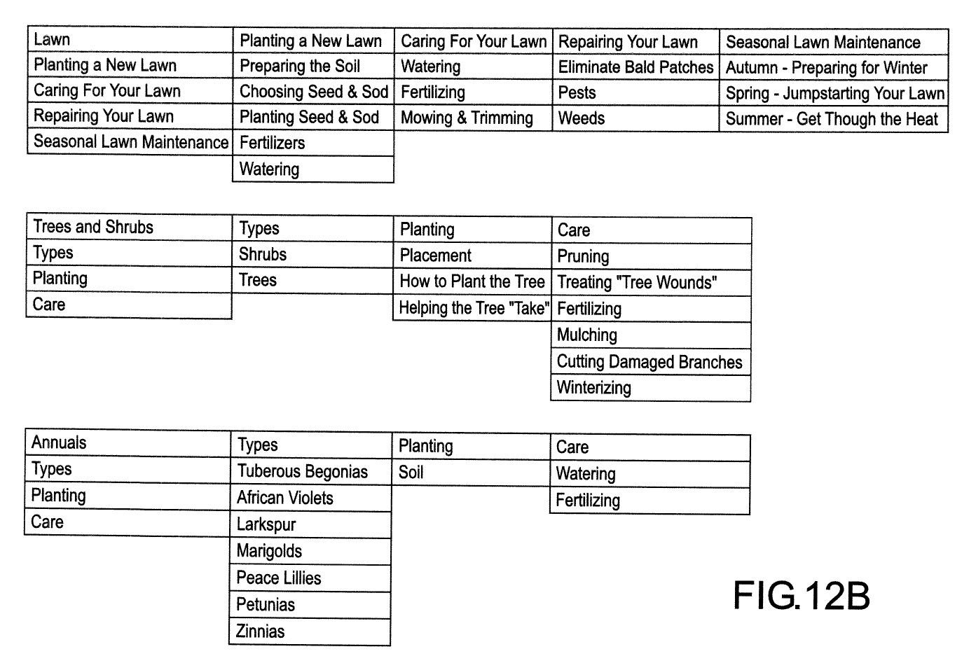

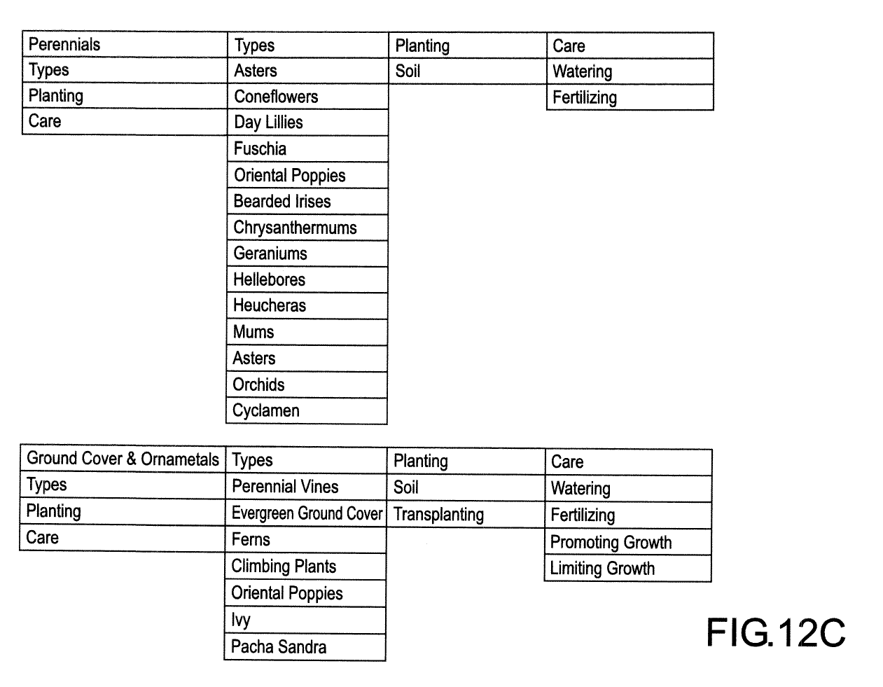

With regard to FIG. 12, the screen menu for a lawn and garden care guide is there illustrated. The main menu includes a master plan or how to design your yard, lawn care, tree and shrub care, annuals, perennials, ground cover, ornamentals and the like. When choosing, for example, trees and shrubs, a subdirectory pops up dealing with types of trees and shrubs, planting of them or their care. When choosing trees, information is provided on how to plant the tree, how to mulch the tree or cut damaged branches, and the like. Similar information is also provided on the data storage device for ground cover or lawns or annuals, as well as all the other items shown on the master directory or menu.

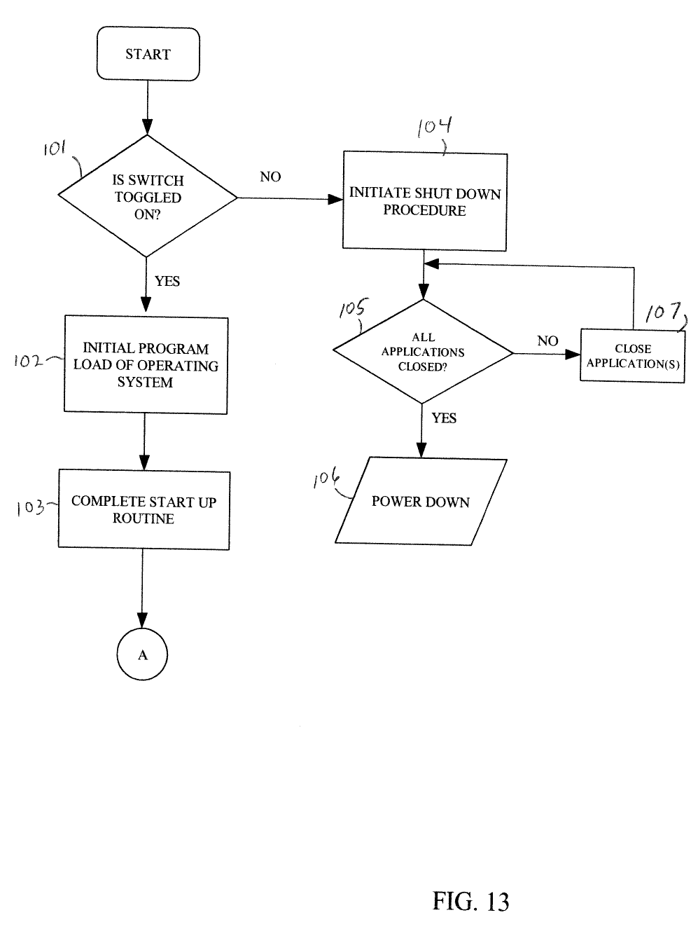

With reference now to FIG. 13, a first part of a flow chart for a software program or routine which can be employed in the system of the present disclosure is there illustrated. In the software program, the first step is whether the power switch is toggled on as at 101. If so, then the initial program load of the operating system is conducted as at 102 and the start up routine is completed as at 103. If the switch is not toggled on, then a shutdown procedure is initiated, as shown at 104. Next, a determination is made as to whether all applications are closed, as shown at block 105. If all the applications are closed, then the system is powered down, see block 106. If all the applications are not yet closed, then the system engages in closing all applications as at 107.

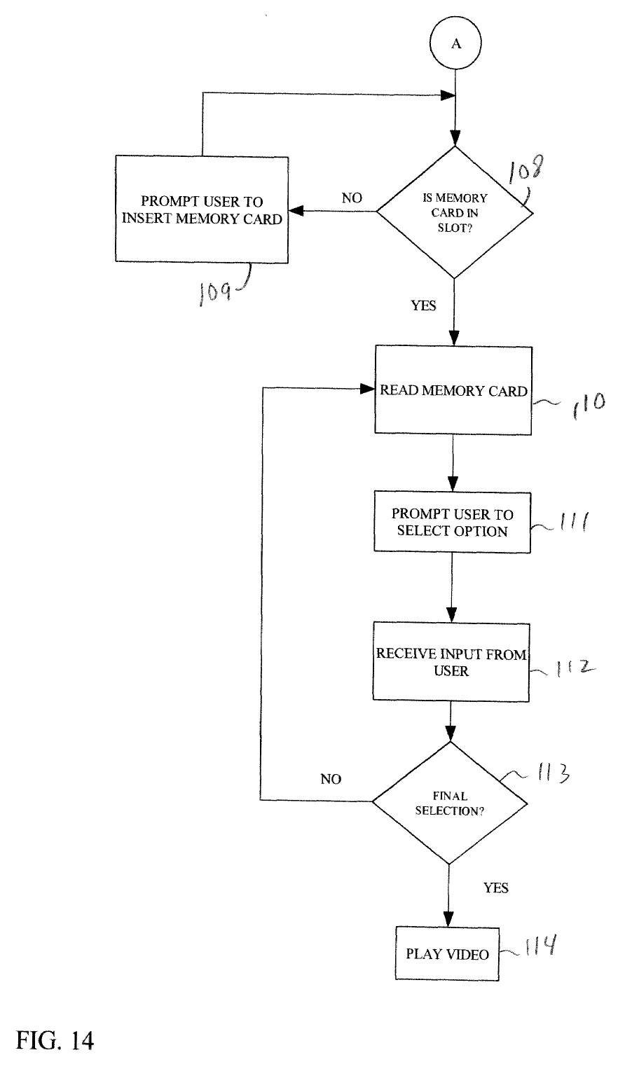

With reference now to FIG. 14, after the startup routine is completed, the system checks to see whether a memory card has been positioned in the slot, see 108. If not, the user may be prompted to insert a memory card, as at 109. If there is a memory card in the slot, the system then reads the memory card (at 110) and prompts the user to select an option, as at 111. Once an input is received from the user, at 112, the system checks to see whether a final selection has been made, as at 113. If so, the video is played as shown in block 114. If not, the memory card is read again.

The present disclosure pertains to a system which enables the user to select a task to be performed. When a task selected, the system automatically shows the user step-by-step how to perform the task with photos, videos, sound clips, printed information and the like. The user then proceeds step-by-step, one step at a time, through the task because the system stops after each step. Such instruction is provided in a portable battery operated form so that the player A can be moved around. Thus, the player can be moved to any desired location by the user because it is portable. When cooking, for example, the player can be moved around from counter to counter, or even brought to a supermarket for access to a shopping list for the dish to be prepared. Similarly, when traveling, there is a menu sorting system that would enable the user to access a sub-directory of the screen menu and find a group of restaurants based on location, type of food, expense, etc. One could then see the outside of the restaurant selected or inside pictures of the restaurant, as well as pictures of signature dishes, the menu and even directions for how to get to the restaurant. The user would also be able to stop and start a neighborhood tour as the user proceeds through that neighborhood.

Because the player A is also usable as a digital photo album, the user can display photos that he or she has taken on their trip, while still on the trip, as well as showing photos the traveler has taken at home to people the traveler meets while travelling. Putting all of this information in a portable battery operated player enables the user to employ the system on the go, in the field.

The instructional system disclosed herein can be considered a revolutionary new type of book, i.e., a book of the future since it contains video clips, images and sound. It has a table of contents just like a book, but it is interactive and helps a person to determine what they are most interested in. Once the user has determined which section he or she is interested in, the pages come alive. For example, for cooking, the user will move step-by-step through a recipe seeing exactly how the food item being prepared should look at every stage. It stops automatically after each step, giving the user time to do what he or she has just seen. In one embodiment, chefs demonstrate each cooking technique being featured.

The system disclosed herein is a new type of media. It is not a book, nor is it TV. It is something in between. It is much more visual than a book, since it contains video clips, images and sound It is also much more practical than television because you can actually cook to it, travel with it, etc. It stops automatically to let the user react. Its computing power lets it be interactive. It also contains much more information than a television show ever could. Plus, it is portable, you can carry it around. TVs and DVDs may be entertaining, but the instant disclosure pertains to a system that enables a person to tackle new things in his or her life and makes intimidating projects easier. In other words, a personal guide is provided for the task that is being undertaken.

What Apple's IPOD player was to music, the instructional system disclosed herein is to many of the important tasks in a person's life, i.e., cooking, traveling, decorating, gardening, fixing up your house, parenting, etc. The system is an interactive treasure trove of information on the selected task, which is the subject of the card or other information storage device pertaining to the category of information at hand. These can include cooking, home repair, home decoration, DIY projects or parenting, or a travel guide or the like. The system disclosed herein may replace many written guides to cooking, parenting, home repair, home decoration and the like. Since it is portable and self-powered, it can be readily and easily transported to any desired location, such as when traveling, gardening or cooking.

The disclosure has been described with reference to several embodiments. Obviously, modifications and alterations will occur to others upon a reading and understanding of this specification. It is intended to include all such modifications and alterations insofar as they come within the scope of the appended claims or the equivalents thereof.

1. A multimedia instructional guide comprising:
a player including:
a display,
a processor connected to said display and to an internal memory,
a media reading module connected to said processor; and
a portable memory device holding a set of discrete video clips organized into sets and subsets and selectively connected to said media reading module, wherein only a selected one video clip is played when a control is activated on the player, and wherein the control needs to be activated a second time before another video clip can be played.

2. The guide of claim 1 wherein said portable memory device comprises a memory card.

3. The guide of claim 1 wherein said player is hand-held.

4. The guide of claim 1 wherein said player is battery powered.

5. A user controlled interactive video system comprising:
a video player adapted to respond to an input command from a user to play a video clip, the player comprising:
a display,
a processor connected to said display,
a data input module connected to said processor,
a control for selectively actuating said data input device; and
an external memory device selectively connected to said data input module, said external memory device carrying a set of discrete video clips each of which can be individually accessed, wherein when said control is actuated, a selected video clip is displayed on the display of the video player and wherein said control needs to be actuated a second time before another video clip can be displayed.

6. The system of claim 5 wherein said video player is hand-held.

7. The system of claim 6 further comprising a battery for powering said video player.

8. The system of claim 5 wherein said external memory device comprises a memory card.

9. The system of claim 5 wherein said set of discrete video clips carried by said external memory device are organized in sets and subsets.

10. The system of claim 9 wherein a table of contents of said set of discrete video clips can be shown on said display so that a user can select a desired video clip for display.
